(19) United States
(12) Patent Application Publication
(10) Pub. No.: US 2016/0104135 A1
(43) Pub. Date: Apr. 14, 2016

(54) Configurable Rolling Payment System and Method for Regular or Telematics Secured Vehicle Financing

(71) Applicant: Joseph Ike Afeli, Dallas, TX (US)

(72) Inventor: Joseph Ike Afeli, Dallas, TX (US)

(21) Appl. No.: 14/706,890

(22) Filed: May 7, 2015

Related U.S. Application Data
(60) Provisional application No. 62/062,858, filed on Oct. 11, 2014.

(51) Int. Cl. G06Q 20/10; G06Q 40/02

(52) U.S. Cl. CPC G06Q 20/102; G06Q 40/025

(57) ABSTRACT

A computer automatable system and method is provided for dynamically managing, calculating and tracking rolling payments (as opposed to installment payments) made by borrowers repaying their finance debt. Rolling payment is an enhanced repayment paradigm or method that flattens and adapts established periodic payments to match a borrower's repayment behavior by flexibly eliminating due dates with its related fixed payment amounts and, instead, enforces an agreed minimum rolling payment balance (RPB) that the borrower must maintain or exceed for the account to be current. To maintain the RPB above the agreed minimum, borrowers can repay any amount (irregular payment amounts) at anytime (irregular payment periods) and from anywhere. The embodied system and method dynamically adapts the payment posting frequency and repayment amount to match precisely the configured repayment objectives of the creditor, hence smoothing out the irregular payment amount and irregular payment period pattern.

### BACKGROUND

A 2007 Federal Reserve board of governor's report to the U.S. Congress on credit scores indicated that close to 40% of the U.S. population had credit scores of 699 or below (near sub prime and sub prime) and this accounted for over 90% of delinquencies. This repayment behavior has not changed over the years and by 2013 resulted in over $10 billion loss in charge-offs for the vehicle financing industry. A national foreclosure report from corelogic.com shows that as at April 2013 about 1.1 million homes were undergoing some sought of foreclosure proceeding. Clearly, the home and commercial mortgage industry as well as other industries like consumer electronics, servicing etc. have not faired better from this repayment behavior. The persistent underlying causes attributable to this repayment behavior, that is, missed payments, slow payments, late payments and none payments, indicate that a more flexible repayment method that adapts to this repayment behavior is needed. Over the years loan installment payments with fixed due dates and fixed minimum payments have not augured well with this segment of the borrowing population. Moreover, since there typically is no immediate persuasive motivation to pay; delinquent borrowers, in the vehicle finance industry for example, often use their vehicles for long periods before they are repossessed and or charged off. The challenge then is developing a configurable method of repayment that adapts itself to the repayment behavior of the borrower while maintaining the loan repayment objectives (term, annual percentage rate, finance charges, total of payments) of the creditor. Such a method of repayment could be further enhanced, in the case of vehicle financing, to motivate the borrower to make payments, and hence additionally securitize the loan for the creditor. Such a repayment method will increase cash flow for the creditor and keep the financed product longer in the hands of the borrower whose payment pattern is irregular (irregular payment amounts and irregular payment periods) but nonetheless a willing and paying borrower.

### SUMMARY

A computer automatable system and method is provided for dynamically managing, calculating and tracking rolling payments (as opposed to installment payments) made by borrowers repaying their finance debt. Rolling payment is an enhanced repayment paradigm or method that flattens and adapts established periodic payments to match a borrower's repayment behavior by flexibly eliminating due dates with its related fixed payment amounts and, instead, enforces an agreed minimum rolling payment balance (RPB) that the borrower must maintain or exceed for the account to be current. To maintain the RPB above the agreed minimum, borrowers can repay any amount (irregular payment amounts) at anytime (irregular payment periods) and from anywhere. The embodied system and method dynamically adapts the payment posting frequency and repayment amount to match precisely the configured repayment objectives of the creditor, hence smoothing out the irregular payment amount and irregular payment period pattern. The RPB, which acts as buffer, is updated in real time as borrowers deposit payments in any amount at anytime and from anywhere. The RPB must be maintained above the agreed and configured threshold by the borrower. Borrowers are notified about critical RPB fluctuations via alerts sent as text messages, emails or directly to the vehicle's infotainment dashboard depending on the configuration. The premise behind rolling payments is that most delinquent borrowers may not have the full payment due on their payment due dates, but they do have something to deposit and can make up the balance incrementally over short irregular payment periods without necessarily defaulting on the creditor's loan repayment objectives.

The rolling payment system and method disclosed here handles and hides the complexity of the implementation from the creditor and borrower. It is additionally understood that although vehicle finance is specifically mentioned in this disclosure, those skilled in the art could implement the system and method disclosed here for any type of loan or finance that requires repayment, be they for mortgage, servicing, consumer electronics, etc. In certain embodiments of the invention, the rolling payment system and method accepts payments from borrowers and sends notifications via email and or text message. These notifications are dynamically determined by current RPB threshold changes. In other words, increases or decreases in the current RPB trigger electronic notification to the borrower's mobile phone, tablet or computer. These embodiments have the potential of providing more cash flow for creditors since borrowers are more likely to make several small irregular payment amounts over several irregular payment periods. This is in contrast to a fixed minimum installment payment that is incomplete on the due date and maybe paid late or not paid at all depending on the severity of the impacting life event. Maintaining the RPB above an agreed and configured threshold or minimum gives the borrower flexibility to cushion life events that impact repayment like job loss, income fluctuations, accidents, sickness or death in the family. Transparent to the borrower and creditor, the rolling payment rules engine, driven by configured creditor repayment objectives, dynamically adapts the payment posting frequency and repayment amount to match precisely the configured repayment objectives of the creditor.

In additional embodiments of the invention, the rolling payment system and method is integrated with a telematics controller to automatically immobilize or mobilize a vehicle in response to the current RPB threshold changes. In other words, increases or decreases in the current RPB could subsequently trigger an infrastructure to vehicle communication. These embodiments enable securitization of the creditor's assets; thereby making it possible to extend credit to near prime and sub prime borrowers with reduced financial risk. For example, this reduces the possibility of vehicle loss or vehicle usage when the borrower flagrantly defaults on their payments. Since the telematics controller, and hence the immobilization or mobilization, is driven by the RPB, current borrowers with little credit history could plausibly be granted more credit with the assumption that the telematics controller additionally secures the vehicle and by extension the deal. Conversely, borrowers whose payment patterns are irregular (irregular payment amounts and irregular payment periods) could be motivated, by the telematics controller, to maintain their rolling payment balances above the agreed and configured threshold.

In other embodiments of the invention, the rolling payment system and method disclosed here is implemented as computer readable programs or modules that are executed in steps and loops while consuming data from various data structures. This facilitates scaling the rolling payment system and method in such a way that thousands or even tens of thousands of vehicles can be automatically immobilized or mobilized without human intervention; making the process cost effective.

In yet other embodiments of the invention, the rolling payment system and method disclosed here are implemented as previously described to store and manage the transmitted precise location data of the vehicle; as well as store and manage data about other inappropriate usages and treatment of the vehicle after immobilization; such as the vehicle being towed elsewhere without authorization, battery disconnect, telematics controller removal, etc. The precise location of the vehicle via GPS data aids efforts to locate the vehicle for repossession and reduces the physical cost of repossession. Moreover, charge offs are reduced drastically as the immobilized vehicle cannot be utilized by the borrower; obliging the borrower to resume payment immediately or abandon the vehicle for repossession a lot earlier in comparison to disappearing with the vehicle or engaging in the usual repossession cat and mouse runaround.

The outlined description, claims and the flow charts further clarify and detail the utility of the invention in its various embodiments.

### BRIEF DESCRIPTION OF THE DRAWINGS

The descriptions of the drawings and flowcharts as presented here are for explanatory purposes and are not intended to limit the invention or the claims associated thereto. The drawings and flowcharts which are part of this specification elaborate the various embodiments of the invention with the purpose of clarifying and elucidating the principles, rules and flow of the invention.

FIG. 1 is an exemplary rolling payment system illustrating the interactive input and output between various processes, interfacing methods and interfacing systems in one embodiment of the invention.

FIG. 2 is a flowchart of one embodiment of a method for initiating access and communicating with the system in FIG. 1.

FIG. 3 is a flowchart of one embodiment of a communication system for receiving an immobilization state verification request, validating the vehicle VIN and saving the received Telematics data. This flowchart additionally illustrates the communication between the rolling payment rules engine, the borrower and the vehicle telematics.

FIG. 4 is a flowchart of one embodiment of a method for the rolling payment rules engine.

FIG. 5 is a flowchart of one embodiment showing some examples of configurable system variables and the exemplified flow of payment data into the interfacing payment system.

FIG. 6 exemplifies simulated payments to illustrate the difference between installment and rolling payments—Delinquent Account.

FIG. 7 exemplifies simulated payments to illustrate the difference between installment and rolling payments—Current Account.

### DETAILED DESCRIPTION

The illustrative embodiments here described in detail pertain to a system and method for dynamically managing, calculating and tracking rolling payments (as opposed to installment payments) made by borrowers repaying their finance debt. Rolling payment is an enhanced repayment paradigm or method that flattens and adapts installment payments to match a borrower's repayment behavior by flexibly eliminating due dates with its related fixed payment amounts and, instead, enforces an agreed minimum rolling payment balance (RPB). To maintain the RPB above the agreed minimum, borrowers can repay any amount (irregular payment amounts) at anytime (irregular payment periods) and from anywhere. The embodied system and method dynamically adapts the payment posting frequency and repayment amount to match precisely the configured repayment objectives of the creditor, hence smoothing out the irregular payment amount and irregular payment period pattern. The RPB, which acts as buffer, is updated in real time as borrowers deposit payments in any amount at anytime and from anywhere. The RPB must be maintained above the agreed and configured threshold by the borrower. Borrowers are notified about critical RPB fluctuations via alerts sent as text messages, emails or directly to the vehicle's infotainment dashboard depending on the configuration. The premise behind rolling payments is that most delinquent borrowers may not have the full payment due on their payment due dates, but they do have something to deposit and can make up the balance incrementally over short irregular payment periods without necessarily defaulting on the creditor's loan repayment objectives. The rolling payment system and method disclosed here handles and hides the complexity of the implementation from the creditor and borrower. It is further understood that anyone skilled in the art can adapt or modify the system and method herein described to suit various applications without deviating from the original scope and intent of this invention.

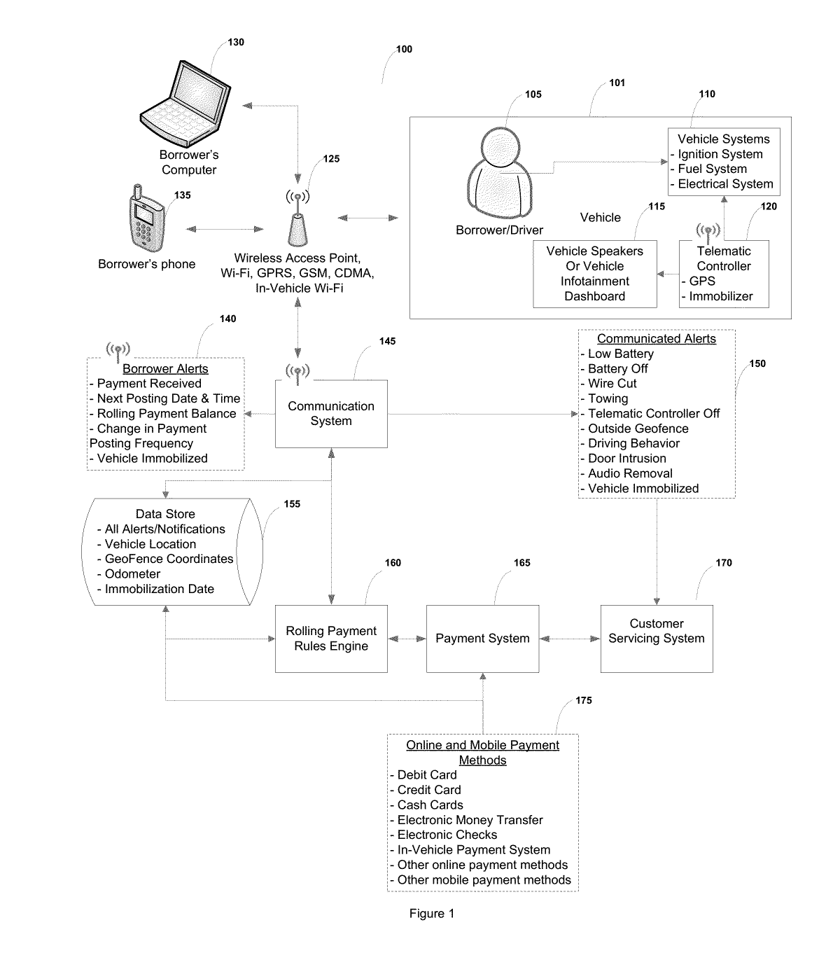

FIG. 1 shows a high level diagram of one embodiment of a configurable rolling payment system for regular financing of any loan or telematics secured vehicle financing. It is understood that the rolling payment system 100 can optionally be implemented as a configurable rolling payment system without the telematics controller as in the case of regular financing, for example in vehicle or mortgage financing. The rolling payment system 100 includes a vehicle 101. It is understood that vehicle as used here refers to any vehicle with an electrical system or fuel system or ignition system and may include trucks, cars, boats, motorcycles, aircrafts, etc. For expediency a car will be used as a point of reference for the rest of this description. The vehicle 101 includes the borrower 105 who has obtained a vehicle loan from a vehicle financing company and who may additionally be the driver. The borrower may be a super prime, prime, near prime or sub prime borrower.

In an embodiment, the vehicle 101 may have a telematics controller 120 installed in a discreet location in the vehicle. The telematics controller 120 tracks and transmits the Global Positioning System (GPS) location of the vehicle based on configured transmission settings. The telematics controller 120 receives mobilization and immobilization instructions wirelessly; via the applicable wireless access 125 and communicates with the configured vehicle system 110 to immobilize or mobilize the vehicle. The telematics controller 120 communicates alerts 150 such as low battery, battery off, wire cut, towing, telematics controller off, outside geofence, driving behavior, door intrusion, audio removal, vehicle location, vehicle immobilized, etc. to a server based communication system 145; via the applicable wireless access 125. It is understood that these communicated alerts 150, additionally and in another embodiment, can be iteratively parsed and programmatically designed to enable vehicle immobilization; especially in the case of a recalcitrant delinquent borrower. The creditor's customer servicing system 170 and servicing team can additionally depend on these communicated alerts 150 to manually override the system and immobilize the vehicle of an intractable delinquent borrower. The telematics controller 120 can communicate alerts to the borrower, if configured, via the vehicle speakers or vehicle infotainment dashboard if configured 115.

Borrower alerts 140 include but are not limited to payment received, next posting date and time, low RPB, current RPB, and change in payment posting frequency. For telematics controller implementations, warnings that the borrower's vehicle will be immobilized if no payment is received are additionally sent, that is, vehicle immobilized. The frequency of borrower alerts 140 are configurable and alerts are delivered to borrower mobile phone 135 as well as a to an email address on record and viewable on the borrower's computer 130. The borrower alerts 140 are pushed to the aforementioned devices 130 and 135 by the communication system 145, via the applicable wireless access 125, with the primary purpose of communicating very quickly and efficiently, thereby reducing the overhead of unnecessary human intervention and hence servicing costs. The processes and methods that generate the borrower alerts and notifications 140 are described later below.

The communication system 145 generates alerts and notifications, retrieves and stores data in the data store 155. Data values stored include but are not limited to all system alerts, generated notifications, vehicle location, geofence coordinates, odometer, and immobilization date. The processes and methods that enable the rolling payment rules engine 160 and payment system 165 to retrieve, update and store data in the data store 155, are described later below. The rolling payment rules engine 160 interfaces with the communication system 145 by receiving a borrower's account number or a vehicle telematics identifier and then performs payment and posting related calculations as detailed later in this description. The payment system 165 receives the calculated data values from the rolling payment rules engine 160 and manages the actual posting of payments. Payments accepted are online and mobile payment methods 175 which include but are not limited to debit cards, credit cards, cash cards, electronic money transfer, electronic checks and in-vehicle payments.

These online and mobile payment methods 175 are electronic transactions and hence support dynamic RPB updates required to make the system responsive to an irregular payment pattern. The customer service system 175 interfaces with the payment system 165 and has a database view of the communicated alerts 150.

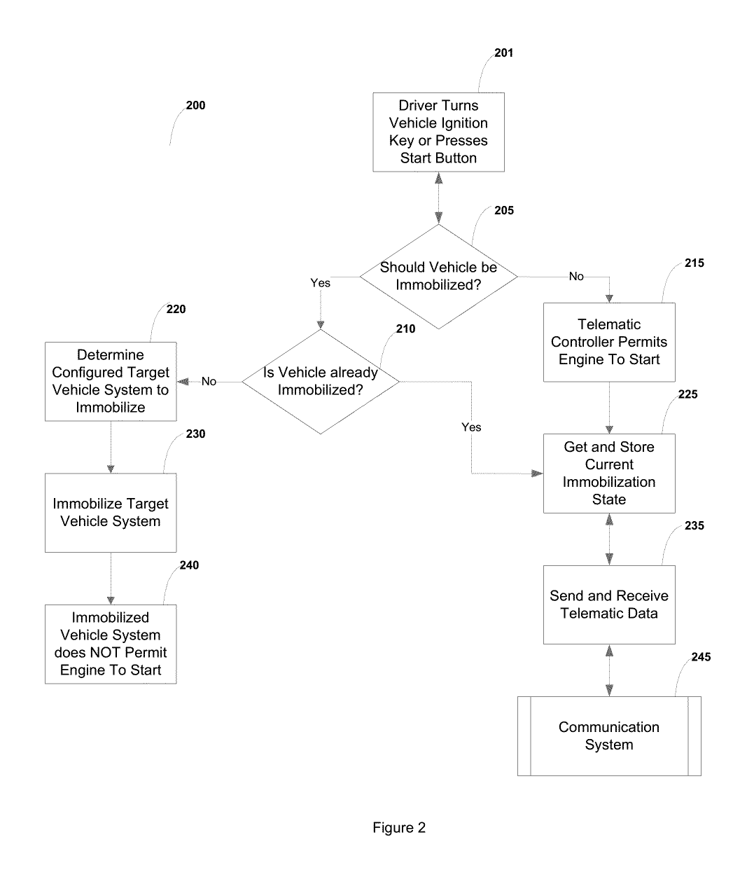

In FIG. 2, the functions of a typical telematics controller 200 are illustrated in a flowchart as an example embodiment. The telematics controller 200 immobilizes or mobilizes a vehicle based on the RPB which is described later. In telematics secured vehicle financing the telematics controller 200 is required. However, in regular financing, for example in vehicle or mortgage financing, a telematics controller 200 will not be applicable or needed. In step 201 the borrower or an assigned driver turns the ignition to start the vehicle being financed by a creditor. The telematics controller 200 evaluates the previously retrieved immobilization state in step 205. If the immobilized state of the vehicle returned by step 205 is true, in other words immobilize the vehicle, then in step 210 it first checks if the vehicle is already immobilized. If the vehicle is already immobilized it gets and stores the current immobilization state in step 225. Step 225 enables the telematics controller 200 to respond quickly to any change in immobilization state in response to the borrowers RPB which may have changed in value since the last time they turned the ignition key. Moreover, if the returned immobilized state of the vehicle should be true, but the vehicle has not been immobilized for the first time, then in step 220 the configured vehicle system to be immobilized is retrieved by the telematics controller 200 and the vehicle system is immobilized in step 230. In step 240 the immobilized vehicle system does not allow the vehicle to start up. It is understood that another restart of the vehicle enables the most current immobilization state to be retrieved and utilized by the telematics controller 200 in the event that the immobilization state has changed since the last vehicle restart.

If the telematics controller detects the immobilized state of the vehicle to be false in step 205, in other words do not immobilize the vehicle since the RPB, as described later, is above the configured threshold; then the telematics controller 200 allows the borrower to start the vehicle. In step 225 the telematics controller 200 gets and stores the current immobilization state and then in step 235 it transmits telematics data to the communication system 245 regardless of the immobilization state. The communication system 245 enables the receipt of telematics data from the telematics controller 200 and communicates the immobilization state received from the rolling payment rules engine back to the telematics controller 200. It is further understood that those skilled in the art may implement the method described in FIG. 2 as different embodiments.

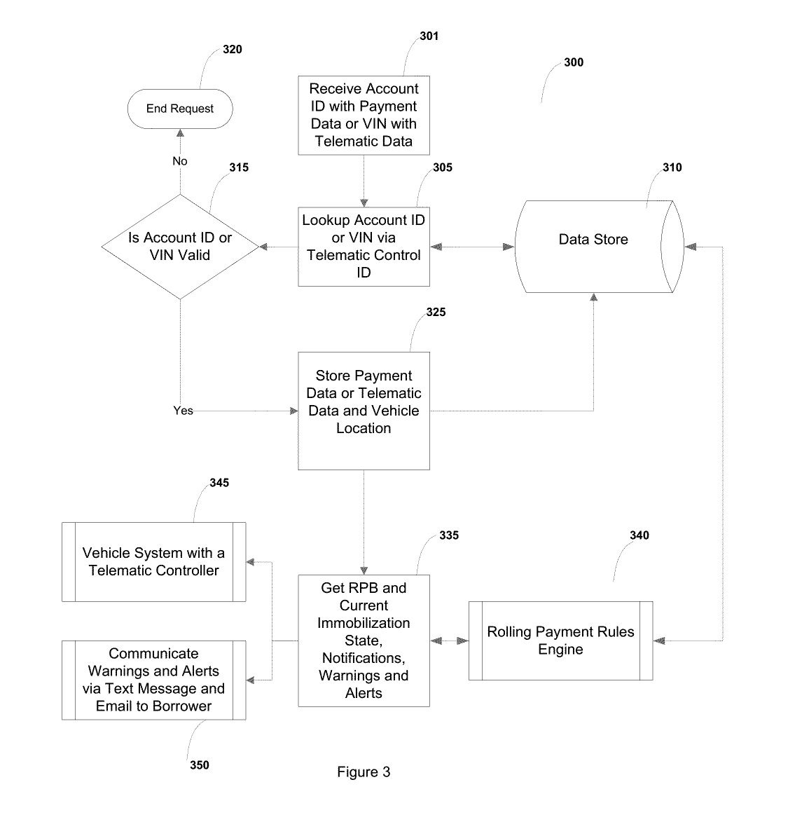

In FIG. 3, the communications system 300 is illustrated in a flowchart as an example embodiment. In regular financing and telematics secured vehicle financing the communications system 300 is required. The communications system 300 communicates directly with the rolling payment rules engine 340 and communicates warnings and alerts to borrowers in step 350. The communications system 300, via the applicable wireless access, facilitates communication between the borrower's electronic message receiving devices 350, the rolling payment system 340 on one hand and the vehicle embedded telematics controller 345 on the other hand if implemented. In step 301 the communications system 300 receives payment data from a user interface device such as a mobile device or a computer or it can receive telematics data from the telematics controller described earlier via GSM/GPRS. The payment data includes the payment amount, payment date, account ID, etc. Telematics data received include but are not limited to low battery, battery off, wire cut, towing, telematics controller off, outside geofence, driving behavior, door intrusion, audio removal, vehicle location, vehicle immobilized, etc. This telematics data from step 301 can be analyzed programmatically to determine the state or usage of the vehicle. For example, battery off in a vehicle with very low RPB could indicate a borrower or accomplice trying to disable the telematics controller 345. An indication of a vehicle being towed when the RPB is very low or when the vehicle is immobilized might indicate a delinquent borrower trying to change the last known garaged location or GPS position. Door intrusion and audio removal could indicate an intruder for a current account and the communications system 300 could send a warning alert to the borrower, or in the case of an immobilized delinquent borrower this could be the first indications of vehicle vandalization.

In step 305 of FIG. 3 the telematics control identification number is used to look up the vehicle's VIN. In the case of regular financing an account ID will be used to lookup the account information for the borrower. Step 315 validates the existence of the account ID or VIN and if it is not an existing account or a registered vehicle the payment or telematics data is not processed further and the request ends in step 320. If the account ID or VIN is valid the payment data or telematics data along with vehicle position are updated in the data store 310 by step 325. The vehicle position which is a GPS coordinate is useful to determine the last known position of a vehicle before it was immobilized. Additionally, it is required to enforce the geofence, that is, the established boundaries beyond which the borrower cannot drive the vehicle. The boundaries of a geofence can be configured to be as wide as the whole world or as small as a city block depending on the creditor's objectives. As the borrower approaches a geofence boundary the borrower receives alerts and if the borrower persists and drives past the established boundary the vehicle could be immobilized the next time the vehicle comes to a stop in a safe location. The servicing team could additionally receive the alerts and manually but safely immobilize the vehicle. The telematics data is updated at a frequency that is configurable.

In step 335, in one embodiment of the system, the communications system 300 requests the current RPB and immobilization state of the vehicle from the rolling payment rules engine 340. The rolling payment rules engine 340, described later, uses the account ID or VIN to identify the vehicle and performs a set of calculations to determine the current RPB and so determine if the borrower is current or if the vehicle should be immobilized. In another embodiment of the system, such as in regular financing, instead of immobilizing a vehicle, the current RPB can be returned directly to an external system at a configured frequency to enable business decisions to be made in real time or alerts could be sent to the borrower and or to the servicing team to initiate repossession activities. Step 335 communicates the immobilization state, described earlier, back to the vehicle system with a telematics controller 345. Moreover, step 335 communicates the notifications, warnings and alerts received to step 350 where they are formatted into a text and or email message and sent to the borrower mobile device or computer or they are displayed in the vehicle infotainment system if configured.

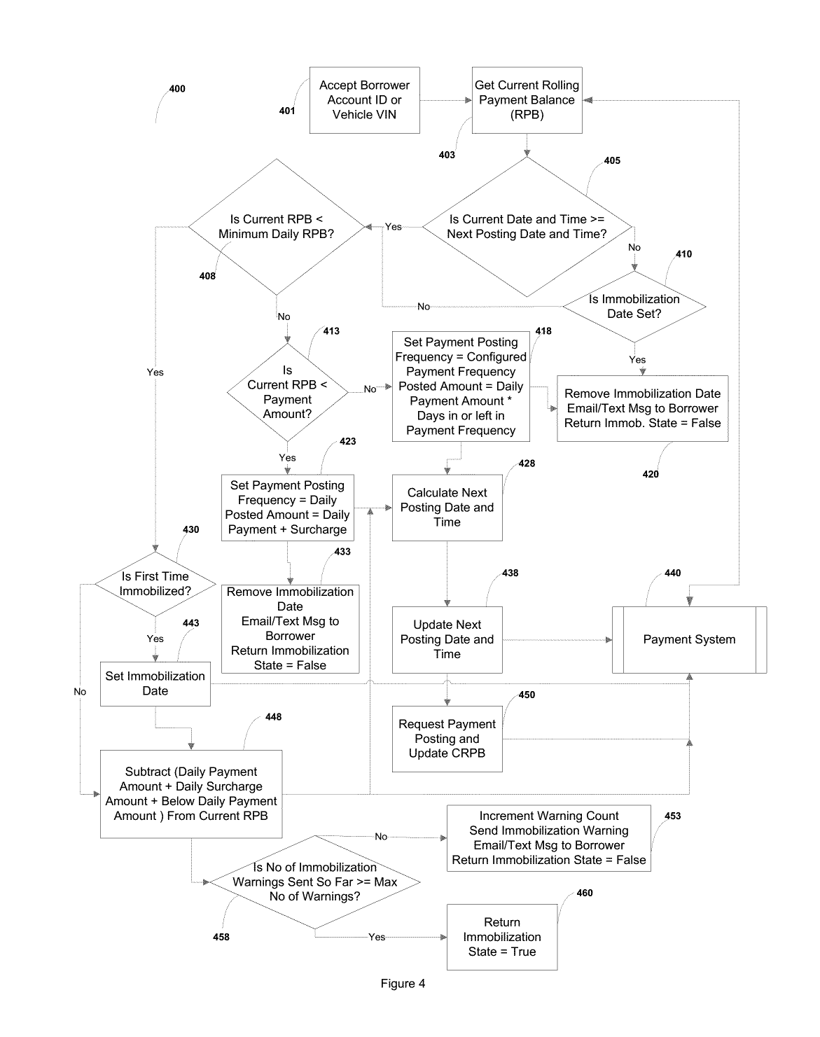

In FIG. 4, the rolling payment rules engine 400 is illustrated in a high level flowchart as an example embodiment. In regular financing and telematics secured vehicle financing the rolling payment rules engine 400 is required. The rolling payment rules engine 400 dynamically manages and calculates the current RPB, amount to be posted, a dynamically determined payment posting frequency and the next posting date and time. These dynamically calculated values help the borrower meet the repayment objectives of the creditor while smoothing out the pattern of irregular payment amounts and irregular payment periods typically portrayed by borrowers repaying their loan. For example, while a borrower may not have the $500 due for installment payment on the first day of the month, because a child took ill and required medical attention, the borrower may have $350 left on the first of the month, $50 four days later from a weekly pay check and after paying short term medical bills. It then becomes easier, for example, to borrow $100 from a friend to make up the balance. In the meantime, the rolling payment rules engine on detecting the change in payment behavior or pattern intelligently adjusts the payment frequency and posted amount to meet the creditor's repayment objectives.

The rolling payment system described in this disclosure provides a mechanism for buffering irregular payment amounts and irregular payment periods occasioned by truly unforeseen upheavals in the life of an otherwise current and good intentioned borrower. A quick simulated comparison, described later, between installment payments with its associated fixed monthly payment amounts plus due dates on the one hand and rolling payments, on the other hand, with flexible payment amounts and dynamically adjusted payment posting dates, underscore the advantages of the rolling payment system and paradigm. Since the rolling payment system is configurable, it allows the creditor to tailor the system to individual borrowers based on their varying repayment behaviors. Additionally, completely new leasing and purchase products could be designed around the rolling payment methodology disclosed here. Moreover, if the telematics aspects of this disclosure are incorporated, in an alternative implementation of the system, the influence on the borrower will be favorable to the creditor who has more control over their vehicle, no different from a credit card issuer who at all times can in one single database table/field update inactivate a $50,000 credit card for delinquency or for some other legitimate policy or terms of usage defaults or abuses. The 100% electronic, online and mobile payment methods described later, enables very fast response times to payment deposits from the borrower and reduces obvious overheads introduced by other methods of payment which maybe inefficient for rolling payments.

In step 401 a borrower's account ID (from a web or mobile payment interface) or a vehicle VIN (from a telematics controller) is accepted and in step 403 the current RPB is requested from the payment system 440 using the already validated account ID or VIN. In step 405 the current date and time is compared with the last calculated or configured payment posting date and time. In the case that the current date and time is less than the calculated or configured payment posting date and time, meaning it is not yet the next posting date and time then step 410 checks to see if there was an immobilization date set previously in a previous immobilization. If there is an immobilization date step 420 removes it, sends a configured notification via email or text message to the borrower, and returns the immobilization state of false to the telematics controller, which means, do not immobilize the vehicle. In regular financing only the configured notification will be sent to the borrower along with the current RPB. Note that for the first processing of a new account, the current RPB requested in step 403 is equal to the first month (or first week, etc.) payment amount plus the minimum initial RPB (minimum initial amount that should be deposited by the borrower to open or initiate the RPB. The minimum initial RPB is set by the creditor.

For example, suppose a borrower with a new account has: Payment Frequency=Monthly, Payment Amount=$500, minimum initial RPB=$550. Then for the first processing by the rolling payment rules engine the current RPB=$1050

For the smooth function of this method, it should be noted that the minimum initial RPB configured could be any amount and due when the first month's payment is received, however, it typically should be equal to or greater than the first month's payment amount or first week's payment amount, etc.; depending on the payment frequency chosen. Additionally, the first month's payment amount and the minimum initial RPB configured should be both due and paid in full at contract consummation. Borrowers who cannot meet these requirements are probably not suited to use the rolling payment methodology. The minimum initial RPB can be treated as an advance.

In step 410 if there was no immobilization date previously set or if in step 405 the current date and time is greater or equal to the calculated or configured payment posting date and time, meaning it is the next posting date and time to perform a payment posting, then step 408 is executed. In regular financing step 410 will always yield a No. In step 408, if the current RPB is less than the minimum daily RPB, that is, daily payment amount plus the associated daily surcharge amount then step 430 evaluates if it is the first time the vehicle was immobilized. In regular financing step 430 will always yield a No. If it is the first time, or a Yes, meaning the vehicle is to be immobilized then the immobilization date is set in step 443 and saved in the data store via the payment system 440. Note that daily payment amount is calculated as: (Monthly Payment Amount * 12)/365 days or (Weekly Payment Amount * 52)/365 days and so on. The daily surcharge amount, administrative surcharge for daily processing, is optional but could be charged when daily posting processing is activated as explained later in this description. The monthly, weekly, etc. payment amounts as used in the formulas above are the periodic payment amounts agreed with the creditor and hence form the input into the rolling payment method. It should be further noted that defaulting the minimum daily RPB to equal the daily payment amount plus the daily surcharge amount as described above ensures that the creditor's repayment objectives are correctly flattened from a periodic payment into a rolling payment. A below daily payment amount fee, explained later, is charged for every day that the current RPB is below the minimum daily RPB.

If the immobilization date has been set previously or it is regular financing or after setting it in step 443, then in step 448 the daily payment amount plus the daily surcharge amount plus below daily payment amount fee are subtracted from the current RPB for everyday that the current RPB is below or less than the minimum daily RPB. In other words, each day the daily payment amount plus the optional daily surcharge amount plus below daily payment amount fee continue to accumulate, and is saved in the data store via the payment system 440. Meanwhile the borrower will receive warnings and alerts at configured intervals in step 453 as evaluated by step 458, while the warning count is incremented. In regular financing a configured notification will be sent via an email and or text message in step 453 to the borrower informing them that their current RPB is now below the minimum daily RPB. In step 458 when the number of configured warnings have been exceeded then the vehicle is immobilized in step 460. In regular financing step 458 will always yield a No. Note that the borrower could return at any time and deposit enough payment to offset the negative current RPB and the borrower can start up the vehicle again the next time they try. In an alternative embodiment where immobilization is not used, such as in regular financing, the return to a positive current RPB could turn off warnings and alerts as well as signal a stop to repossession or foreclosure activities.

For example, suppose a borrower has a Payment Frequency=Monthly, Payment Amount=$500, minimum initial RPB=$550, with current RPB before posting=$10 as at June 1 12 am; then Daily Payment Amount=($500* 12)/365=$16.44, Daily Surcharge Amount=$0.56, Below Daily Payment Amount Fee=$1 and minimum daily RPB=($16.44+$0.56)=$17. From the foregoing if current RPB<minimum daily RPB for each daily processing during the last 12 days then: the current RPB after posting on June 12 12:01 am=$10−(12 days * ($16.44+$0.56+$1))=−$206.

The borrower will receive notifications at the configured notification frequency as explained above. Assuming the borrower returns June 12 at 2 pm and makes a payment of $365 then: a posted amount of $206 is posted or debited from the account and the current RPB before posting on June 13 12 am=−$206+$365=$159.

In step 408, if the current RPB is greater than the minimum daily RPB then step 413 compares the current RPB to the payment amount configured. If the current RPB is less than the payment amount, then step 423 sets the payment posting frequency to daily and the posted amount to daily payment amount plus the daily surcharge amount. Step 428 calculates the next posting date and time and updates this in the data store as described later. Step 433 removes the immobilization date, sends the configured notification via an email and or text message to the borrower and returns an immobilization state of false if the request came from a telematics controller as explained earlier. For regular financing step 433 will only send a configured notification via an email and or text message to the borrower.

For example, suppose a borrower has a Payment Frequency (PF)=Monthly, Payment Amount=$500, minimum initial RPB=$550, with the Next Posting Date and Time=June 1 12 am and current RPB before posting=$390 as at June 1 12 am, Daily Payment Amount (DPA)=($500 * 12)/365=$16.44, Daily Surcharge Amount (DSA)=$0.56 and Minimum daily RPB=($16.44+$0.56)=$17.

If current RPB>minimum daily RPB and current RPB<Payment Amount then Payment Posting Frequency=Daily (changed from Monthly), Posted Amount=DPA+DSA ($16.44+$0.56) (since posting is now daily), current RPB after posting=current RPB−(DPA+DSA)=$390−($16.44+$0.56)=$373 and the Next Posting Date and Time=June 2 12 am.

In the example above the DPA+DSA will continue to be posted daily until the borrower deposits sufficient funds such that the current RPB is now greater than the configured payment amount for the payment frequency. Continuing with the previous example above, suppose the borrower makes a payment of $420 at 3 pm on June 9 then the Sum of daily Posted Amount daily during the elapsed period=((DPA+DSA) * No of Days elapsed in PF)=($17 * 8 days—that is from June 2 12 am to June 9 12 am)=$136. The current RPB before posting=current RPB+Payment made, that is, current RPB before posting=($373−$136)+$420=$657 as at June 10 12:00 am.

In step 418 the current RPB is greater than or equal to the payment amount for the configured payment frequency, hence the payment posting frequency is set to the configured payment frequency which could be weekly, biweekly, monthly, etc. Additionally, the posted amount is set to the daily payment amount multiplied by the number of days in configured payment frequency or the number of days remaining in that configured payment frequency. If immobilization date was set earlier, step 420 removes it and returns the immobilization state of false. For regular financing and telematics financing the configured notification is sent via an email and or text message. Step 428 calculates the next posting date and time and step 438 updates this in the data store through the payment system 440. Step 450 requests payment posting and updates the current RPB.

For example, suppose a borrower has a Payment Frequency (PF)=Monthly, Payment Amount=$500, minimum initial RPB=$550, Next Posting Date and Time=June 1 12:00 am, current RPB before posting=$390 as at May 30 12 am, Daily Payment Amount (DPA)=($500 * 12)/365=$16.44, Daily Surcharge Amount (DSA)=$0.56 and Minimum daily RPB=($16.44+$0.56)=$17. Suppose the borrower had made a payment of $420 on May 30 at 7 pm. Since current RPB before posting=current RPB+Payment made, then current RPB before posting=$390+$420=$810 as at June 1 12:00 am; additionally Payment Posting Frequency=Monthly (unchanged), Posted Amount for the days left in PF=((DPA) * No of Days in PF)=(($16.44) * 30 days in June)=$493.20. Therefore current RPB after posting=current RPB−((DPA) * No of Days left in PF) Current RPB after posting=$810−($16.44 * 30 days in June)=$316.80 as at June 1 12:01 am and thee Next Posting Date and Time=July 1 12 am.

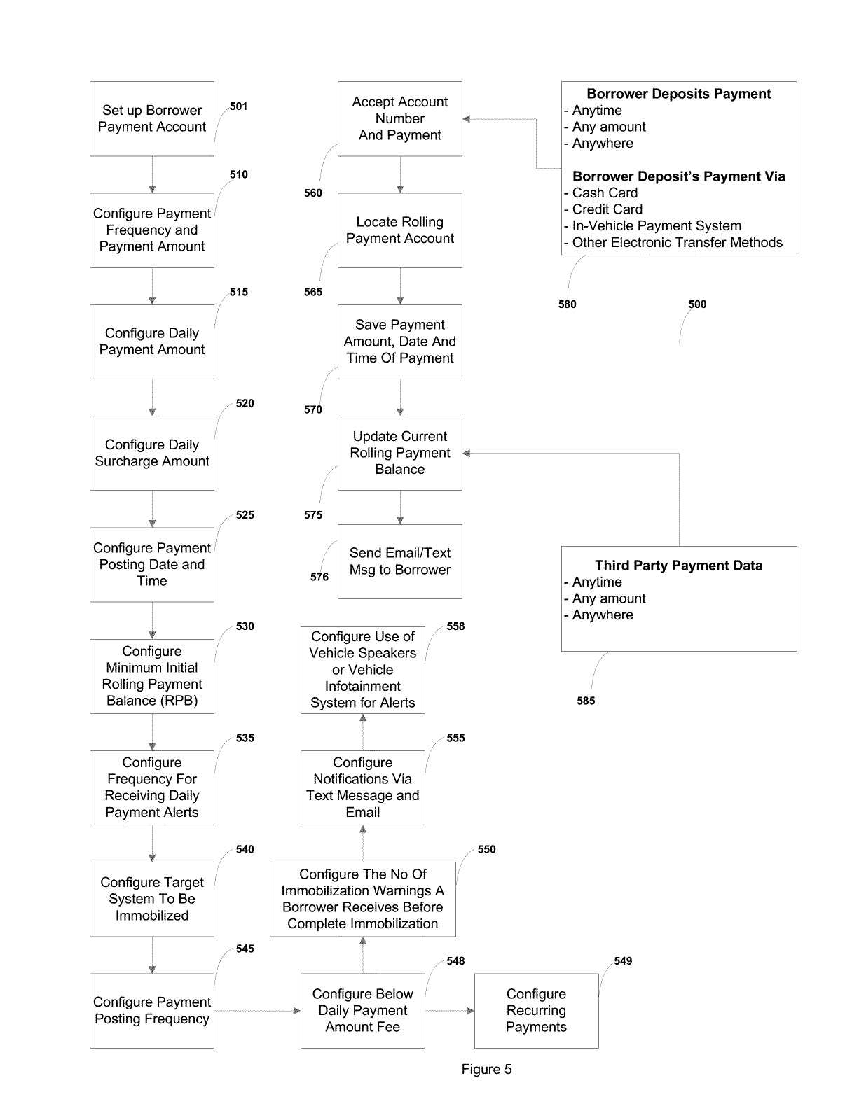

In FIG. 5, the payment system 500 is illustrated in a detailed flowchart as an example embodiment. It is understood that the steps outlined can be executed in any other and that some steps can be omitted. It is further understood that the payment system 500 disclosed here could be implemented as an interface to a larger and more complex payment system whereby the payment system 500 interfaces between the rolling payment rules engine and the complex payment system. This application architectural approach hides the implementation necessary to utilize the rolling payment rules engine.

After the borrower is setup in step 501, in step 510 the payment frequency and payment amount are configured. This would typically be monthly, but could be weekly, biweekly, etc. This is the default payment frequency for posting periodic payments when the current RPB is greater than or equal to the payment amount, hence it is recommended that the minimum initial RPB, described shortly, be equal or greater than the payment amount configured for the payment frequency. For example, if the configured payment frequency of monthly has the payment amount of $500 configured; then the minimum initial RPB could be configured at $500 or greater.

In step 515 the daily payment amount is configured. This is the amount that will be deducted from the current RPB, during payment posting, when the current RPB is less than the payment amount configured. It is additionally used to derive the total amount to be posted for the payment frequency duration or parts thereof as exemplified earlier. In step 520 the daily surcharge amount is configured. This is the optional administrative surcharge that the borrower could be charged for daily posting processing that occurs when the current RPB is less than the payment amount configured or the current RPB is less than the minimum daily RPB. In step 525 the posting date and time for payment is configured. This typically will be for the first payment. After the first payment subsequent payments that recur or are manual will default to the same day of the month. For example, when the payment posting frequency is daily, the next posting date and time will be recalculated on a daily basis. However, when the borrower deposits enough to pay out for the rest of the configured payment frequency remaining, then the posting date and time defaults back to the configured payment posting date and time which, for example, could be the 1^{st} of the month at 12 am. In this case the payment posting frequency will be monthly.

In step 530 the minimum initial RPB is configured to a set value. This is the minimum amount that should be initially deposited by the borrower into the RPB of their account. While the minimum initial RPB is recommended to be equal or greater than the payment amount configured for the payment frequency, as described earlier above, it could be configured to any value. The frequency for receiving daily payment alerts is configured in step 535 while the target system to be immobilized is configured in step 540. The frequency for posting payments, especially the initial payment is configured in step 545. This value will change depending on the current RPB as described earlier above. The below daily payment amount fee is configured in step 548. Typically, the below daily payment amount fee is a payment late fee divided by the number of days in the configured payment frequency and is applied everyday the RPB is below the minimum daily RPB.

In step 549 recurring payments are set up or enabled. During processing, when a reoccurring payment attempt fails, the borrower is notified but regardless of a recurring payment success or failure payments will be posted depending on the RPB and not the result of the failed transaction. This protects the borrower by buffering the payment exception. In step 550 the number of times a borrower receives immobilization alerts before their vehicle is immobilized is configured. This value can be zero for no warnings or set to higher values to give the borrower flexibility. Notification via text message and email are configured in step 555 while the use of vehicle speakers or vehicle infotainment system for alerts is configured in step 558.

The payment system 500 accepts an account number and the amount to be deposited into the borrower's RPB, via step 560. After the first month's payment and minimum initial RPB has been setup the borrower can deposit any amount, anywhere and at anytime. Provided that deposits are sufficient to maintain the current RPB above the minimum daily RPB, then the account is in good standing and in the case of a vehicle loan, the vehicle will remain mobilized. This applies equally for regular vehicle financing and telematics secured financing. To facilitate the dynamic nature of the RPB the payments in step 580 are made with cash cards, credit cards, in-vehicle payment system or other electronic forms of payment that can be made online or from a mobile device. The account number is used to locate the RPB in step 565 of the payment system 500 or in an external complex payment system. Step 570 saves the amount and date and time of the payment while step 575 updates the current RPB. Step 576 sends the current RPB and a payment received notification via email and or text message to the borrower. If payment is received in an external third party payment system, payment data from such a system could be passed to the payment system 500 in batch via step 585 and the current RPB could be updated in step 576, maintained and communicated to the affected borrowers in batch via step 576.

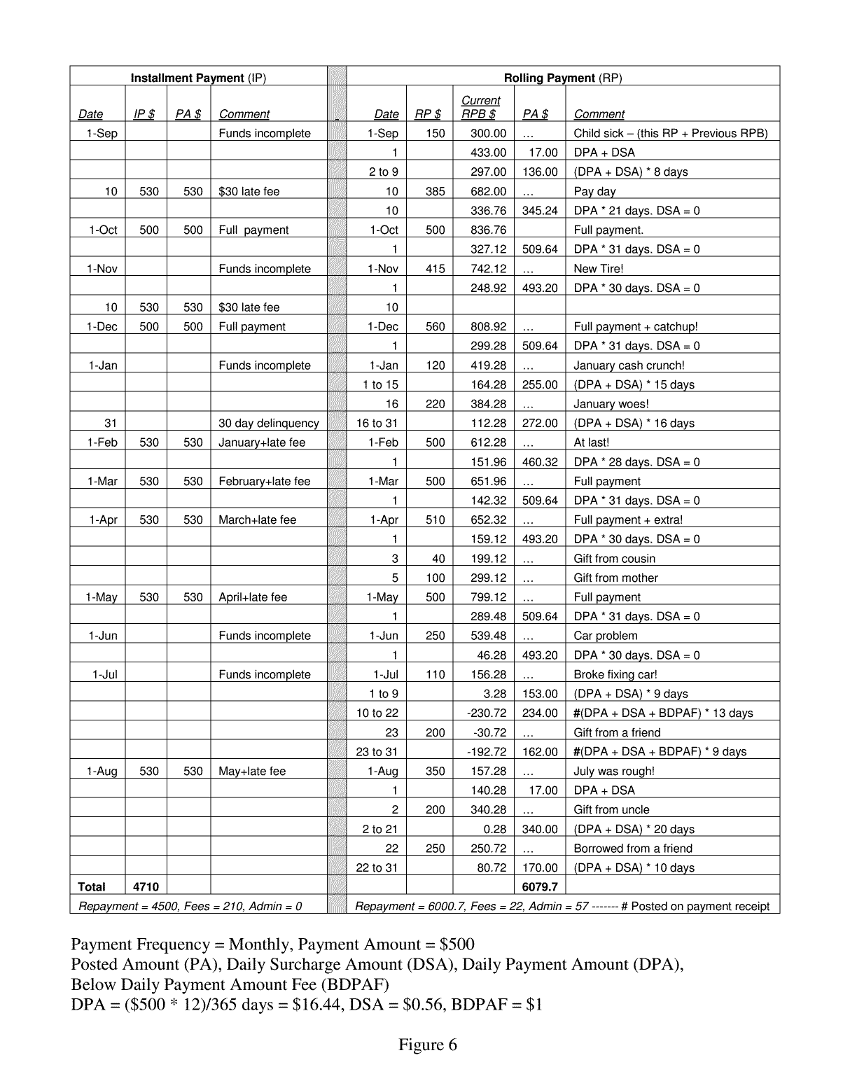

FIG. 6 depicts simulated payments to illustrate the difference between installment and rolling payments. Both simulations are for the same delinquent borrower at the same points in time as they face serious repayment impacting life events. The assumption is that none of the two repayment methods will resort to phone calls to make any negotiated repayments and additionally that the borrower would make irregular payments at irregular periods if the creditor had a system that supported and processed it accordingly. The rolling payment simulation exemplifies the typical pattern of irregular and unpredictable payment amounts and periods that some borrowers exhibit. Note that the current RPB buffered and leveled out the irregular payment amounts and periods. In comparison, the installment payment simulation did let the borrower default immediately. The rolling payment system clearly shows its advantage at the end of one year, with more cash flow which is a key repayment objective, in comparison with the simulated installment payment system.

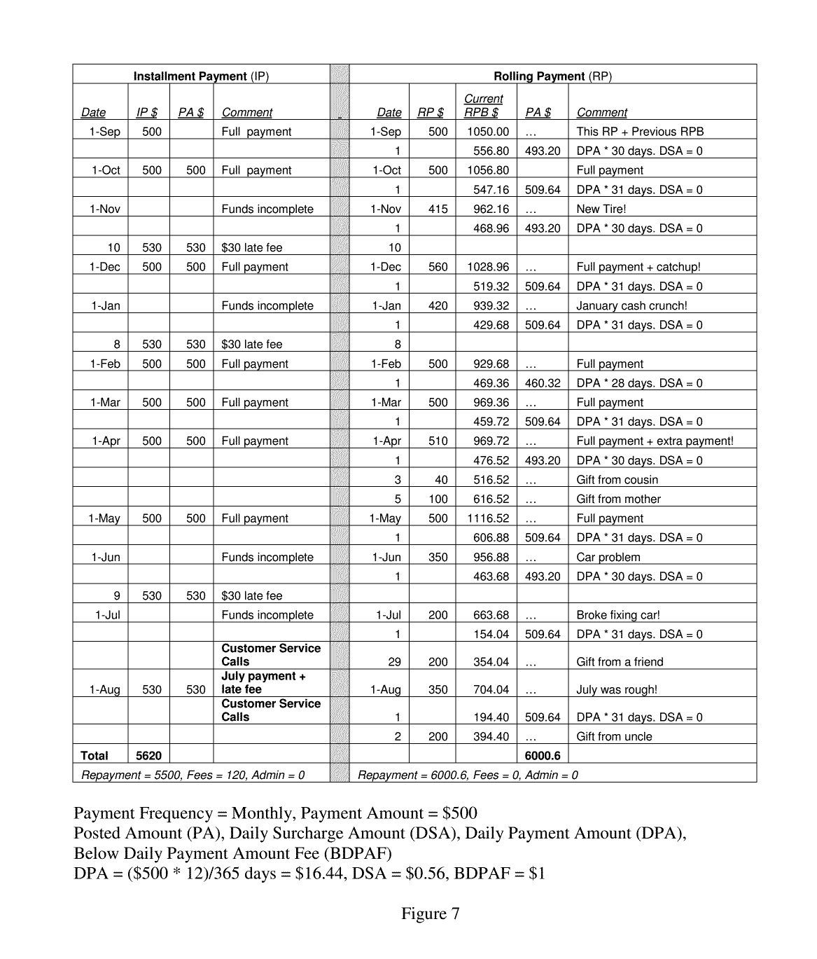

FIG. 7 depicts simulated payments to illustrate the difference between installment and rolling payments. Both simulations are for the same borrower at the same points in time as they face infrequent repayment impacting life events. The rolling payment simulation exemplifies the typical pattern of irregular and unpredictable payment amounts and periods that some borrowers demonstrate. The current RPB buffers and levels out the irregular payment amounts and periods. It is noteworthy that the repayment objectives of the creditor are met and exceeded by the rolling payment system; moreover, at the end of the 12 months the borrower still has an outstanding RPB.

What is claimed is:

1. A computer automatable system for dynamically managing, calculating and tracking rolling payments, the system comprising: computer processors with computer memory located on a computer server, wherein the computer memory contains a plurality of software instructions that the computer processor can access to execute and perform a method that comprises: receiving borrower payments, made in any amount to repay their debt, without the restriction of a minimum due amount;
receiving borrower payments at any time without the restriction of a due date; and instead enforcing a minimum daily rolling payment balance that the borrower must maintain or exceed for the account to be current; dynamically calculating and adapting the actual payment posting frequency and repayment amount of the borrower at system posting time, based on the perceived or observed repayment pattern and frequency of the borrower, so that it matches precisely the configured repayment objectives of the creditor; calculating a dynamically changing next payment posting date and time depending on the borrower's repayment behavior or pattern; receiving a borrower's rolling payment identification number through a user interface or electronic file transfer, wherein the identification number, for an account or telematics controller, uniquely identifies the borrower in the rolling payment system, and the user interface is a web page or mobile device screen, or remote device or remote computer system or a remote telematics controller installed in a vehicle; validating the existence and usability of the rolling payment identification number; accepting, validating and saving the payment data, related to the rolling payment identification number, in real time, in a data store as borrowers deposit payments in any amount at anytime and from anywhere to increase their rolling payment balance; calculating a new rolling payment balance for the borrower's account;
updating the current rolling payment balance for the borrower account in the data store with the newly calculated rolling payment balance; dynamically determining the type of notification to be sent to the borrower based on the threshold changes of the current rolling payment balance; notifying the borrower via email and or text message of critical current rolling payment balance fluctuations, payment receipts, alerts, warnings, messages pertaining the state of the account; receiving securely and validating for completeness and usability a borrower's rolling payment configuration data and personal information, via a user interface or electronic file transfer as described above, and saving them in any data store; immobilizing or mobilizing a plurality of telematics controllers based on the current rolling payment balance of each borrower/vehicle owner who has a telematics controller installed in their vehicle; and configuring and maintaining a minimum daily rolling payment balance threshold which the borrower should maintain or exceed for the account to be current and thus enable rolling payment postings.

2. The method of claim 1 wherein the notification to the borrower is performed by sending the message, email or text message, to one or more of the following that belongs to the borrower: computer, laptop, mobile phone, tablet, and other mobile devices.

3. The method of claim 1, wherein the minimum daily rolling payment balance enforced is equal to or greater than (the daily payment amount+the optional daily surcharge amount).

4. The method of claim 1, wherein the current rolling payment balance is equal to (the minimum initial rolling payment balance)+(initial payments made at account opening) when the account is opened for the first time.

5. The method of claim 1, wherein the current rolling payment balance before posting is equal to:
(a) ((current rolling payment balance)+(payments made at anytime)) when a manual payment is made and current rolling payment balance is greater than zero; or
(b) ((current rolling payment balance)+(payments made at anytime)) when a manual payment is made and current rolling payment balance is less than zero (Note: first, a posted amount equal to: (−1 * current rolling payment balance) when rolling payment balance will become positive or a posted amount equal to: (payment received) when rolling payment balance will remain negative) must be posted before computing the current rolling payment balance when this condition is met); or
(c) ((current rolling payment balance)+(recurring payment made at anytime which is equal to (daily payment amount * number of days in the payment frequency))) when a recurring payment is successfully made.

6. The method of claim 1, wherein the current rolling payment balance after posting is equal to:
(a) (current rolling payment balance−(daily payment amount+daily surcharge amount+below daily payment amount fee)) when the current rolling payment balance is below or less than the minimum daily rolling payment balance; or
(b) (current rolling payment balance−(daily payment amount+daily surcharge amount)) when the current rolling payment balance is greater than the minimum daily rolling payment balance but less than the configured payment amount; or
(c) (current rolling payment balance−(daily payment amount * number of days in or left in the payment frequency)) when the current rolling payment balance is greater than or equal to the configured payment amount.

7. The method of claim 6, wherein when recurring payment fails then payment is automatically, without human intervention, posted from the current rolling payment balance as computed in the referenced claim, and later a notification is sent to the borrower indicating the changed current rolling payment balance.

8. The method of claim 6, wherein the payment posting frequency is equal to:
(a) daily, when the current rolling payment balance is below or less than the minimum daily rolling payment balance; or (b) daily, when the current rolling payment balance is greater than the minimum daily rolling payment balance but less than the configured payment amount; or
(c) the configured payment frequency, when the current rolling payment balance is greater than or equal to the configured payment amount.

9. The method of claim 6, wherein the next payment posting date and time is dynamically calculated and equal to:
(a) (the last calculated next payment posting date and time+1 day) when the current rolling payment balance is below or less than the minimum daily rolling payment balance; or
(b) (the last calculated next payment posting date and time+1 day) when the current rolling payment balance is greater than the minimum daily rolling payment balance but less than the configured payment amount; or
(c) (the last calculated next payment posting date and time+number of days in or left in the payment frequency) when the current rolling payment balance is greater than or equal to the configured payment amount.

10. The method of claim 6, wherein the posted amount is equal to:
(a) (daily payment amount+daily surcharge amount+below daily payment amount fee) when the current rolling payment balance is below or less than the minimum daily rolling payment balance; or
(b) (daily payment amount+daily surcharge amount) when the current rolling payment balance is greater than the minimum daily rolling payment balance but less than the configured payment amount; or
(c) (daily payment amount * number of days in or left in the payment frequency) when the current rolling payment balance is greater than or equal to the configured payment amount.

11. The method of claim 6, wherein the posting action is performed by subtracting the dynamically calculated posted amount from the current rolling payment balance, at the dynamically calculated next payment posting date and time, when payments are received or during the regular posting process when payments are not received.

12. The method of claim 6, wherein a telematics controller remotely installed on a vehicle receives a wireless instruction to:
(a) turn on vehicle immobilization when the current rolling payment balance is below or less than the minimum daily rolling payment balance and the optional number of warnings, from 0 to the configured maximum, to the borrower has been exhausted; or
(b) turn off, or maintain vehicle immobilization in the off position, when the current rolling payment balance is greater than the minimum daily rolling payment balance but less than the configured payment amount; or
(c) turn off, or maintain vehicle immobilization in the off position, when the current rolling payment balance is greater than or equal to the configured payment amount.

13. The method of claim 6, wherein a plurality of borrowers' telematics controllers can be turned on or off automatically, without human intervention, depending on the current rolling payment balance of each borrower and their associated vehicle's telematics controller.

14. The method of claim 1, wherein loans repaid or serviced using the rolling payment method are subject to terms and conditions that additionally comprises: the current rolling payment balance must be maintained above zero on a daily basis to keep the account current; a loan is delinquent when the current rolling payment balance remains less than zero for the number of days that constitute the payment frequency; a penalty fee, below daily payment amount fee, is incurred for every day the current rolling payment balance is below the daily payment amount; and all other installment payment terms and conditions apply as applicable.
